(19) United States
(12) Patent Application Publication
(10) Pub. No.: US 2013/0120287 A1
(43) Pub. Date: May 16, 2013

(54) TOUCH PANEL

(71) Applicants: Sang Hwan Oh, Gyunggi-do (KR); Youn Soo KIM, Gyunggi-do (KR); Hyun Jun KIM, Gyunggi-do (KR)

(72) Inventors: Sang Hwan Oh, Gyunggi-do (KR); Youn Soo KIM, Gyunggi-do (KR); Hyun Jun KIM, Gyunggi-do (KR)

(73) Assignee: SAMSUNG ELECTRO-MECHANICS CO., LTD., Gyunggi-do (KR)

(21) Appl. No.: 13/587,704

(22) Filed: Aug. 16, 2012

(30) Foreign Application Priority Data
Nov. 10, 2011 (KR) 1020110117157

(51) Int. Cl. G06F 3/041

(52) U.S. Cl. 345/173

(57) ABSTRACT

Disclosed herein is a touch panel including: a transparent substrate; a first electrode pattern formed in a mesh pattern on one surface of the transparent substrate; a second electrode pattern formed in a mesh pattern on the other surface of the transparent; a conductive film formed in a planar shape on the other surface of the transparent substrate; and a display provided in a direction of the other surface of the transparent substrate. The conductive film with the second electrode pattern is formed in a planar shape, such that the noise generated from the display may be effectively blocked, thereby making it possible to prevent electromagnetic interference (EMI) from being generated.

### CROSS REFERENCE TO RELATED APPLICATION

This application claims the benefit of Korean Patent Application No. 10-2011-0117157, filed on Nov. 10, 2011, entitled “Touch Panel”, which is hereby incorporated by reference in its entirety into this application.

### BACKGROUND OF THE INVENTION

1. Technical Field

The present invention relates to a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

However, according to the rapid advancement of an information-oriented society, since the use of computers has increasingly expanded, it is difficult to efficiently operate a product using only the keyboard and the mouse currently serving as the input device. Therefore, necessity for a device which is simple, has less malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of a display such as an electronic organizer, a flat panel display device including a liquid crystal display (LCD) device, a plasma display panel (PDP), an electroluminescence (El) element, or the like, and a cathode ray tube (CRT) to thereby be used to allow a user to select desired information while viewing the display.

Meanwhile, the touch panel is classified into a resistive type touch panel, a capacitive type touch panel, an electromagnetic type touch panel, a surface acoustic wave (SAW) type touch panel, and an infrared type touch panel. These various types of touch panels are adapted for an electronic product in consideration of a signal amplification problem, a resolution difference, the degree of difficulty of designing and processing technologies, an optical characteristic, an electrical characteristic, a mechanical characteristic, resistance to an environment, an input characteristic, durability, and economical efficiency. Currently, the resistive type touch panel and the capacitive type touch panel have been prominently used in a wide range of fields.

Meanwhile, in the touch panel, research into a technology of forming an electrode pattern using a metal as disclosed in Korean Patent Laid-Open Publication No. 10-2010-0091497 has been actively conducted. As described above, when the electrode pattern is made of the metal, electric conductivity is excellent and demand and supply is smooth. However, in the case of forming the electrode pattern using the metal, since the electrode pattern should be formed to have a thin width in a micrometer (μm) unit in order to prevent the electrode pattern from being recognized by users, noise generated from the display may not be blocked. The noise of the display causes electromagnetic interference (EMI) to deteriorate performance of the touch panel.

### SUMMARY OF THE INVENTION

The present invention has been made in an effort to provide a touch panel capable of effectively blocking noise generated from an image screen display by using a conductive film formed in a planar shape.

According to a preferred embodiment of the present invention, there is provided a touch panel including: a transparent substrate; a first electrode pattern formed in a mesh pattern on one surface of the transparent substrate; a second electrode pattern formed in a mesh pattern on the other surface of the transparent; a conductive film formed in a planar shape on the other surface of the transparent substrate; and a display provided in a direction of the other surface of the transparent substrate.

The first electrode pattern or the second electrode pattern may be made of copper (Cu), aluminum (Al), gold (Au), silver (Ag), titanium (Ti), palladium (Pd), chromium (Cr) or a combination thereof.

The first electrode pattern or the second electrode pattern may be made of metal silver formed by exposing/developing a silver halide emulsion layer.

The conductive film may be made of poly-3,4-ethylenedioxythiophene/polystyrenesulfonate (PEDOT/PSS), polyaniline, polyacetylene, or polyphenylenevinylene.

The touch panel may further include: a first electrode wiring formed at an edge of the first electrode pattern; and a second electrode wiring formed at an edge of the second electrode pattern and the conductive film.

The first electrode wiring may be formed integrally with the first electrode pattern; and the second electrode wiring may be formed integrally with the second electrode pattern.

According to another preferred embodiment of the present invention, there is provided a touch panel including: a first transparent substrate; a first electrode pattern formed in a mesh pattern on one surface of the first transparent substrate; a second transparent substrate; a second electrode pattern formed in a mesh pattern on one surface of the second transparent; a conductive film formed in a planar shape on one surface of the second transparent substrate; an adhesive layer adhering one surface of the first transparent substrate and one surface of the second transparent substrate to each other; and a display provided in a direction of the other surface of the second transparent substrate.

The first electrode pattern or the second electrode pattern may be made of copper (Cu), aluminum (Al), gold (Au), silver (Ag), titanium (Ti), palladium (Pd), chromium (Cr) or a combination thereof.

The first electrode pattern or the second electrode pattern may be made of metal silver formed by exposing/developing a silver halide emulsion layer.

The conductive film may be made of poly-3,4-ethylenedioxythiophene/polystyrenesulfonate (PEDOT/PSS), polyaniline, polyacetylene or polyphenylenevinylene.

The touch panel may further include: a first electrode wiring formed at the edge of the first electrode pattern; and a second electrode wiring formed at the edge of the second electrode pattern and the conductive film.

The first electrode wiring may be formed integrally with the first electrode pattern; and the second electrode wiring may be formed integrally with the second electrode pattern.

According to another preferred embodiment of the present invention, there is provided a touch panel including: a transparent substrate; a first electrode pattern formed in a mesh pattern on one surface of the transparent substrate; an insulating layer formed on one surface of the transparent substrate; a second electrode pattern formed in a mesh pattern on an exposed surface of the insulating layer; a conductive film formed in a planar shape on the exposed surface of the insulating layer; and a display provided in a direction of the exposed surface of the insulating layer.

The first electrode pattern or the second electrode pattern may be made of copper (Cu), aluminum (Al), gold (Au), silver (Ag), titanium (Ti), palladium (Pd), chromium (Cr) or a combination thereof.

The first electrode pattern or the second electrode pattern may be made of metal silver formed by exposing/developing a silver halide emulsion layer.

The conductive film may be made of poly-3,4-ethylenedioxythiophene/polystyrenesulfonate (PEDOT/PSS), polyaniline, polyacetylene or polyphenylenevinylene.

The touch panel may further include: a first electrode wiring formed at the edge of the first electrode pattern; and a second electrode wiring formed at the edge of the second electrode pattern and the conductive film.

The first electrode wiring may be formed integrally with the first electrode pattern; and the second electrode wiring may be formed integrally with the second electrode pattern.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of a touch panel according to a first preferred embodiment of the present invention;

FIG. 2 is a cross-sectional view of a touch panel according to a first preferred embodiment of the present invention;

FIG. 3 is an exploded perspective view of a touch panel according to a second preferred embodiment of the present invention;

FIG. 4 is a cross-sectional view of a touch panel according to the second preferred embodiment of the present invention;

FIG. 5 is an exploded perspective view of a touch panel according to a third preferred embodiment of the present invention; and

FIG. 6 is a cross-sectional view of a touch panel according to the third preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

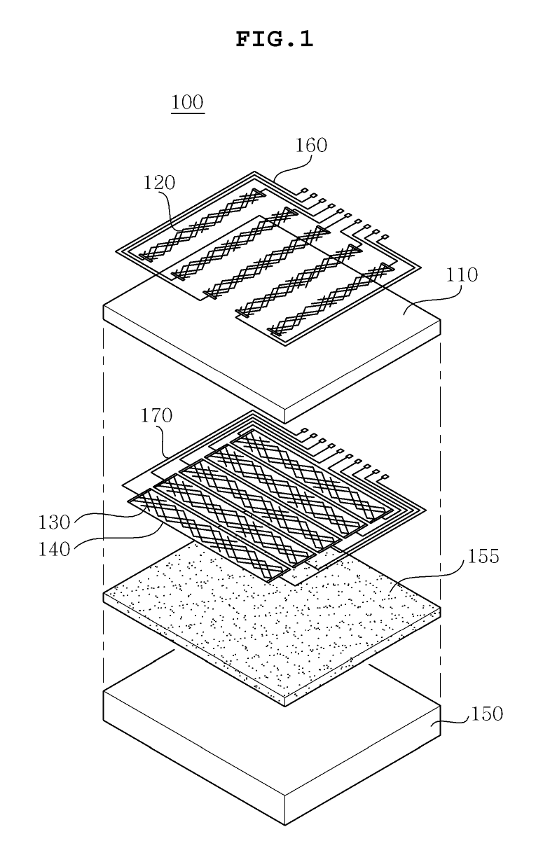

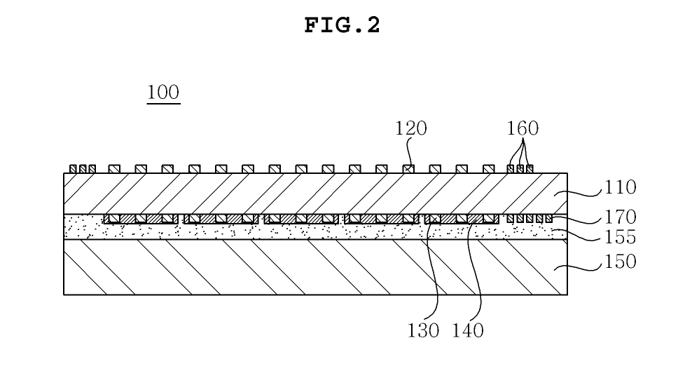

FIG. 1 is an exploded perspective view of a touch panel according to a first preferred embodiment of the present invention, and FIG. 2 is a cross-sectional view of a touch panel according to the first preferred embodiment of the present invention.

As shown in FIGS. 1 and 2, the touch panel 100 according to the preferred embodiments of the present invention includes a transparent substrate 110, a first electrode pattern 120 formed in a mesh pattern on one surface of the transparent substrate 110; a second electrode pattern 130 formed in a mesh pattern on the other surface of the transparent substrate 110; a conductive film 140 formed in a planar shape on the other surface of the transparent substrate 110; and a display 150 provided in a direction of the other surface of the transparent substrate 110.

The transparent substrate 110 serves to provide a region on which the first and second electrode patterns 120 and 130 and the conductive film 140 are formed. Here, the transparent substrate 110 needs to have support force capable of supporting the first and second electrode patterns 120 and 130 and the conductive film 140 and transparency allowing a user to recognize an image provided by a display 150. In consideration of the support force and the transparency described above, the transparent substrate 110 may be made of polyethylene terephthalate (PET), polycarbonate (PC), polymethylmethacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing a K resin), glass, tempered glass, or the like, but is not necessarily limited thereto.

Meanwhile, in order to activate both sides of the transparent substrate 110, a high frequency treatment or a primer treatment may be performed. Adhesion between the transparent substrate 110 and the first and second electrode patterns 120 and 130 or the transparent substrate 110 and the conductive film 140 may be improved by activating both sides of the transparent substrate 110.

The first electrode pattern 120, the second electrode pattern 130 and the conductive film 140 serve to generate a signal at the time of a touch by a user to thereby allow a controller to recognize a touch coordinate. Here, the first electrode pattern 120 is formed on one surface of the transparent substrate 110, and the second electrode pattern 130 and the conductive film 140 are formed on the other surface of the transparent substrate 110, such that the first electrode pattern 120 faces the second electrode pattern 130 and the conductive film 140 based on the transparent substrate 110.

Specifically, the first electrode pattern 120 or the second electrode pattern 130 may be made of copper (Cu), aluminum (Al), gold (Au), silver (Ag), titanium (Ti), palladium (Pd), chromium (Cr), or a combination thereof to be formed in a mesh pattern. Here, the first electrode pattern 120 and the second electrode pattern 130 may be formed by a plating process or a depositing process. Meanwhile, in the case in which the first electrode pattern 120 and the second electrode pattern 130 are made of copper (Cu), surfaces of the first electrode pattern 120 and the second electrode pattern 130 may be black-oxide treated. Here, the black-oxide treatment indicates treatment in which Cu₂O or CuO is precipitated by oxidizing the surfaces of the first electrode pattern 120 and the second electrode pattern 130, wherein the Cu₂O is brown and is thus referred to as a brown oxide and the CuO is black and is thus referred to as a black oxide. As described above, the surfaces of the first electrode pattern 120 and the second electrode pattern 130 are black-oxide treated to thereby prevent light reflection, thereby making it possible to improve visibility of the touch panel 100.

Meanwhile, the first electrode pattern 120 or the second electrode pattern 130 may also be made of metal silver formed by exposing and developing a silver halide emulsion layer, in addition to the metal as described above.

In addition, the conductive film 140 is formed in a planar shape by using a conductive polymer having excellent flexibility and a simple coating process. Here, the conductive polymer includes poly-3,4-ethylenedioxythiophene/polystyrenesulfonate (PEDOT/PSS), polyaniline, polyacetylene, or polyphenylenevinylene. In addition, the conductive film 140 may be formed by a dry process, a wet process, or a direct patterning process. Here, an example of a dry process includes sputtering, evaporation, or the like, an example of a wet etching process includes dip coating, spin coating, roll coating, spray coating, or the like, and an example of a direct patterning process includes screen printing, gravure printing, inkjet printing, or the like.

As described above, the first electrode pattern 120 and the second electrode pattern 130 are all formed in mesh patterns. Since an opening part is provided between the mesh patterns, it may be difficult to block the noise generated from the display 150. However, since the conductive film 140 with the second electrode pattern 130 is formed in a planar shape on the other surface of the transparent substrate 110, the noise generated from the display 150 may be effectively blocked, thereby making it possible to prevent electromagnetic interference (EMI) from being generated. In addition, both of the conductive film 140 in a planar shape and the second electrode pattern 130 in the mesh pattern are formed to be conducted to each other, thereby making it possible to decrease the sheet resistance. Therefore, the conductive film 140 is formed to have a thin thickness, thereby making it possible to increase the transmittance of the touch panel 100. In addition, both of the conductive film 140 in the planar shape and the second electrode pattern 130 in the mesh pattern are formed, such that the number of lines of the second electrode pattern 130 which may be recognized by the user may be reduced, thereby making it possible to improve the visibility of the touch panel 100.

Meanwhile, the first electrode pattern 120, the second electrode pattern 130, and the conductive film 140 are formed in a bar shape pattern in drawings of the present invention; but is not limited thereto. The first electrode pattern 120, the second electrode pattern 130, and the conductive film 140 may be formed in all patterns as known in the art, such as a rhombic pattern, a rectangular pattern, a triangular pattern, a circular pattern, and the like.

The display 150, which outputs an image, is provided in a direction of the other surface of the transparent substrate 110. Here, the display 150 includes a liquid crystal display device (LCD), a plasma display panel (PDP), an electroluminescence (EL), a cathode ray tube (CRT) or the like. In addition, the display 150 may be adhered to the other surface of the transparent substrate 110 by using an optical clear adhesive (OCA) 155. Meanwhile, the noise is generated in the display 150; however, as described above, the noise is blocked by the conductive film 140 formed of a planar shape, thereby making it possible to prevent the EMI from being generated.

In addition, the first electrode wiring 160 receiving an electrical signal from the first electrode pattern 120 is formed at the edge of the first electrode pattern 120, and the second electrode wiring 170 receiving an electrical signal from the second electrode pattern 130 and the conductive film 140 is formed at the edge of the second electrode pattern 130 and the conductive film 140. Here, the first electrode wiring 160 is formed integrally with the first electrode pattern 120, and the second electrode wiring 170 is formed integrally with the second electrode pattern 130, thereby making it possible to simplify a manufacturing process, and reduce lead time.

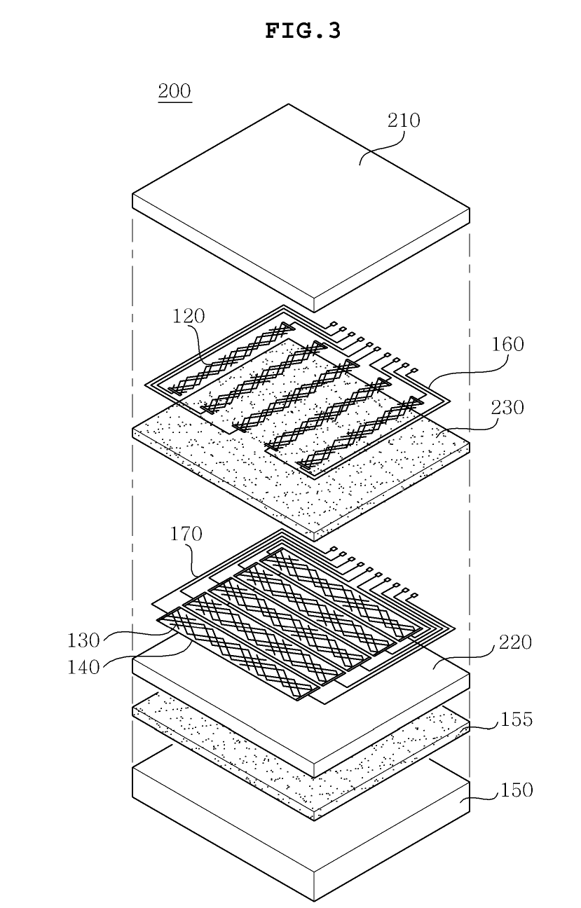

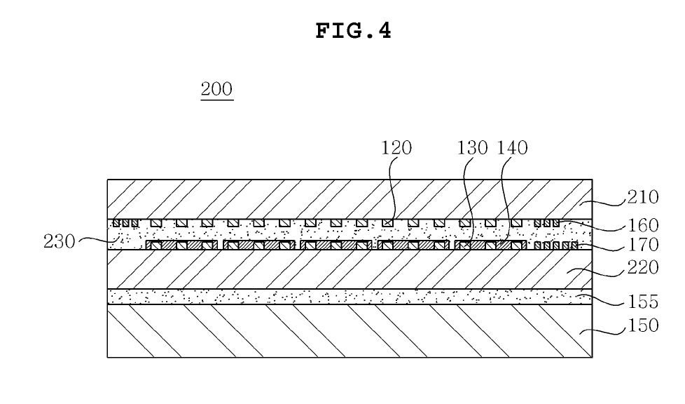

FIG. 3 is an exploded perspective view of a touch panel according to a second preferred embodiment of the present invention, and FIG. 4 is a cross-sectional view of a touch panel according to the second preferred embodiment of the present invention.

As shown in FIGS. 3 and 4, a touch panel 200 according to the preferred embodiments of the present invention includes a first transparent substrate 210, a first electrode pattern 120 formed in a mesh pattern on one surface of the transparent substrate 210; a second transparent 220; a second electrode pattern 130 formed in a mesh pattern on one surface of the second transparent 220; a conductive film 140 formed in a planar shape on one surface of the second transparent substrate 220; an adhesive layer 230 adhering one surface of the first transparent substrate 210 and one surface of the second transparent substrate 220; and a display 150 provided in a direction of the other surface of the second transparent substrate 220.

When compared with the touch panel 100 according to the first preferred embodiment of the present invention, in the touch panel 200 according to the second preferred embodiment of the present invention, the first electrode pattern 120 is formed on the first transparent substrate 210, and the second electrode pattern 130 and the conductive film 140 are formed on the second transparent substrate 220. Therefore, contents overlapping with those of the first preferred embodiment of the present invention will be briefly described, and differences therebetween will be mainly described.

The first and second transparent substrates 210 and 220 serve to provide a region in which the first and second electrode patterns 120 and 130 and the conductive film 140 are formed. Here, a high-frequency treatment or a primer treatment may be performed in order to activate one of the surfaces of the first and second transparent substrates 210 and 220. As described above, one of the surfaces of the first and second transparent substrates 210 and 220 are activated, thereby making it possible to improve the adhesion between the first and second transparent substrates 210 and 220 and the first and second electrode patterns 120 and 130 or the second transparent substrate 220 and the conductive film 140.

Meanwhile, the first transparent substrate 210 may be a window provided at the outermost side of the touch panel 200. In the case in which the first transparent substrate 210 is the window, since the first electrode pattern 120 is formed directly on the window, a process of forming the first electrode pattern 120 on a separate transparent substrate and then attaching the separate transparent substrate to the window is omitted, thereby making it possible to simplify a manufacturing process and reduce the entire thickness of the touch panel 200.

The first electrode pattern 120, the second electrode pattern 130 and the conductive film 140 serve to generate a signal at the time of a touch by a user to thereby allow a controller to recognize a touch coordinate. Here, the first electrode pattern 120 is formed on one surface of the first transparent substrate 210, and the second electrode pattern 130 and the conductive film 140 are formed on one surface of the second transparent substrate 220. Therefore, the first electrode pattern 120 faces the second electrode pattern 130 and the conductive film 140 based on the adhesive layer 230.

Specifically, the first electrode pattern 120 or the second electrode pattern 130 may be made of copper (Cu), aluminum (Al), gold (Au), silver (Ag), titanium (Ti), palladium (Pd), chromium (Cr), or a combination thereof to be formed in a mesh pattern. Meanwhile, in the case in which the first electrode pattern 120 and the second electrode pattern 130 are made of copper (Cu), surfaces of the first electrode pattern 120 and the second electrode pattern 130 may be black-oxide treated, thereby making it possible to prevent light reflection.

Meanwhile, the first electrode pattern 120 or the second electrode pattern 130 may also be made of metal silver formed by exposing and developing the silver halide emulsion layer, in addition to the metal as described above.

In addition, the conductive film 140 may be formed in a planar shape by using a conductive polymer including poly-3,4-ethylenedioxythiophene/polystyrenesulfonate (PEDOT/PSS), polyaniline, polyacetylene, or polyphenylenevinylene. As described above, since the conductive film 140 with the second electrode pattern 130 is formed in a planar shape on one surface of the second transparent substrate 220, the noise generated from the display 150 may be effectively blocked, thereby making it possible to prevent the EMI from being generated. In addition, both of the conductive film 140 in a planar shape and the second electrode pattern 130 in a mesh pattern are formed to decrease the sheet resistance, such that thereby making it possible to increase the transmittance of the touch panel 200. In addition, both of the conductive film 140 in the planar shape and the second electrode pattern 130 in the mesh pattern are formed, such that the number of lines of the second electrode pattern 130 which may be recognized by the user may be reduced, thereby making it possible to improve the visibility of the touch panel 200.

The adhesive layer 230 serves to adhere one surface of the first transparent substrate 210 and one surface of the second transparent substrate 220 to each other, such that the first electrode pattern 120 and the second electrode pattern 130 or the first electrode pattern 120 and the conductive film 140 are disposed so as to face each other. Here, an example of the adhesive layer 230 includes an optical clear adhesive (OCA), but is not specifically limited thereto.

The display 150, which outputs an image, is provided in a direction of the other surface of the second transparent substrate 220. Here, the display 150 may be adhered to the other surface of the second transparent substrate 220 by using an optical clear adhesive (OCA) 155.

In addition, the first electrode wiring 160 receiving an electrical signal from the first electrode pattern 120 is formed at the edge of the first electrode pattern 120, and the second electrode wiring 170 receiving an electrical signal from the first electrode pattern 130 and the conductive film 140 is formed at the edge of the second electrode pattern 130 and the conductive film 140. Here, the first electrode wiring 160 is formed integrally with the first electrode pattern 120, and the second electrode wiring 170 is formed integrally with the second electrode pattern 130, thereby making it possible to simplify a manufacturing process and reduce the lead time.

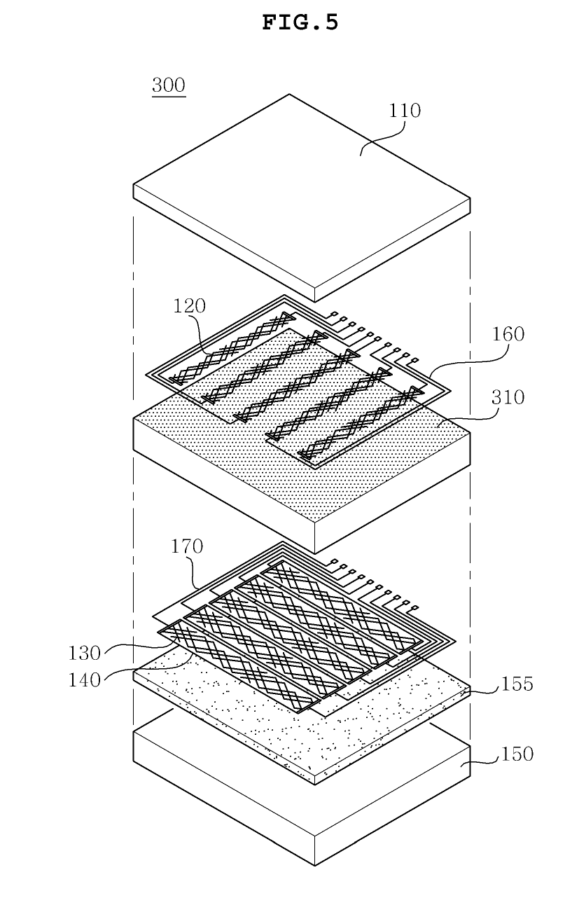

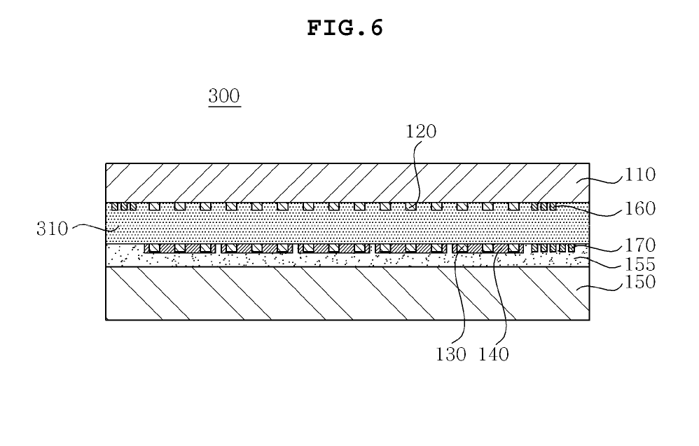

FIG. 5 is an exploded perspective view of a touch panel according to a third preferred embodiment of the present invention, and FIG. 6 is a cross-sectional view of a touch panel according to the third preferred embodiment of the present invention.

As shown in FIGS. 5 and 6, the touch panel 300 according to the preferred embodiments of the present invention includes a transparent substrate 110, a first electrode pattern 120 formed in a mesh pattern on one surface of the transparent substrate 110; an insulating layer 310 formed on one surface of the transparent substrate 110; a second electrode pattern 130 formed in a mesh pattern on an exposed surface of the insulating layer 310; a conductive film 140 formed in a planar shape on the exposed surface of the insulating layer 310; and a display 150 provided in a direction of the exposed surface of the insulating layer 310.

When compared with the touch panels 100 and 200 according to the first and second preferred embodiment of the present invention, in the touch panel 300 according to the third preferred embodiment of the present invention, the first electrode pattern 120 is formed on the first transparent substrate 110, and the second electrode pattern 130 and the conductive film 140 are formed on the insulating layer 310. Therefore, contents overlapping with those of the first and second preferred embodiment of the present invention will be briefly described, and differences therebetween will be mainly described.

The transparent substrate 110 serves to provide a region on which the first electrode pattern 120 is formed. Here, in order to activate one side of the transparent substrate 110, a high frequency treatment or a primer treatment may be performed. As described above, one surface of the transparent substrate 110 is activated, thereby making it possible to improve the adhesion between the transparent substrate 110 and the first electrode pattern 120.

Meanwhile, the transparent substrate 110 may be a window provided at the outermost side of the touch panel 300. In the case in which the transparent substrate 110 is the window, since the first electrode pattern 120 is formed directly on the window, a process of forming the first electrode pattern 120 on a separate transparent substrate and then attaching the separate transparent substrate to the window is omitted, thereby making it possible to simplify a manufacturing process and reduce the entire thickness of the touch panel 300.

The insulating layer 310, which serves to protect the first electrode pattern 120 and provide a region in which the second electrode pattern 130 and the conductive film 140 are formed, is formed on one surface of the transparent substrate 110 so as to cover the first electrode pattern 120. Here, the insulating layer 310 may be made of an epoxy-based or an acrylic-based resin, a SiOx thin film, a SiNx thin film, or the like by a printing method, a chemical vapor deposition (CVD) method, a sputtering method, or the like.

The first electrode pattern 120, the second electrode pattern 130 and the conductive film 140 serve to generate a signal at the time of a touch by a user to thereby allow a controller to recognize a touch coordinate. Here, the first electrode pattern 120 is formed on one surface of the transparent substrate 110, and the second electrode pattern 130 and the conductive film 140 are formed on the exposed surface of the insulating layer 310. Therefore, the first electrode pattern 120 faces the second electrode pattern 130 and the conductive film 140 based on the insulating layer 310.

Specifically, the first electrode pattern 120 or the second electrode pattern 130 may be made of copper (Cu), aluminum (Al), gold (Au), silver (Ag), titanium (Ti), palladium (Pd), chromium (Cr), or a combination thereof to be formed in a mesh pattern. Meanwhile, in the case in which the first electrode pattern 120 and the second electrode pattern 130 are made of copper (Cu), surfaces of the first electrode pattern 120 and the second electrode pattern 130 may be black-oxide treated, thereby making it possible to prevent light reflection.

Meanwhile, the first electrode pattern 120 or the second electrode pattern 130 may also be made of metal silver formed by exposing and developing the silver halide emulsion layer, in addition to the metal as described above.

In addition, the conductive film 140 may be formed in a planar shape by using a conductive polymer including poly-3,4-ethylenedioxythiophene/polystyrenesulfonate (PEDOT/PSS), polyaniline, polyacetylene, or polyphenylenevinylene. As described above, since the conductive film 140 with the second electrode pattern 130 is formed in a planar shape on one surface of the second transparent substrate 220, the noise generated from the display 150 may be effectively blocked, thereby making it possible to prevent the EMI from being generated. In addition, both of the conductive film 140 in a planar shape and the second electrode pattern 130 in a mesh pattern are formed to decrease the sheet resistance, such that the conductive film 140 is formed to have a thin thickness, thereby making it possible to increase the transmittance of the touch panel 300. In addition, both of the conductive film 140 in the planar shape and the second electrode pattern 130 in the mesh pattern are formed, such that the number of lines of the second electrode pattern 130 which may be visually recognized by the user may be reduced, thereby making it possible to improve the visibility of the touch panel 300.

The display 150, which outputs an image, is provided in a direction of the exposed surface of the insulating layer 310. In addition, the display 150 may be adhered to the exposed surface of the insulating layer 310 by using an optical clear adhesive (OCA) 155.

In addition, the first electrode wiring 160 receiving an electrical signal from the first electrode pattern 120 is formed at the edge of the first electrode pattern 120, and the second electrode wiring 170 receiving an electrical signal from the second electrode pattern 130 and the conductive film 140 is formed at the edge of the second electrode pattern 130 and the conductive film 140. Here, the first electrode wiring 160 is formed integrally with the first electrode pattern 120, and the second electrode wiring 170 is formed integrally with the second electrode pattern 130, thereby making it possible to simplify a manufacturing process and reduce the lead time.

As set forth above, according to the present invention, the conductive film formed in a planar shape is used to effectively block noise generated from the display, thereby making it possible to prevent electromagnetic interference (EMI) from being generated.

In addition, according to the present invention, both of the conductive film formed in the planar shape and the second electrode pattern formed in the mesh pattern are used to decrease the sheet resistance, such that the conductive film is formed to have a thin thickness, thereby making it possible to increase the transmittance of the touch panel.

Further, according to the present invention, both of the conductive film formed in the planar shape and the second electrode pattern formed in the mesh pattern are used to reduce the number of lines of the second electrode patterns which may be recognized by the user, thereby making it possible to improve the visibility of the touch panel.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel comprising:
a transparent substrate;
a first electrode pattern formed in a mesh pattern on one surface of the transparent substrate;
a second electrode pattern formed in a mesh pattern on the other surface of the transparent;
a conductive film formed in a planar shape on the other surface of the transparent substrate; and
a display provided in a direction of the other surface of the transparent substrate.

2. The touch panel as set forth in claim 1, wherein the first electrode pattern or the second electrode pattern is made of copper (Cu), aluminum (Al), gold (Au), silver (Ag), titanium (Ti), palladium (Pd), chromium (Cr) or a combination thereof.

3. The touch panel as set forth in claim 1, wherein the first electrode pattern or the second electrode pattern is made of metal silver formed by exposing/developing a silver halide emulsion layer.

4. The touch panel as set forth in claim 1, wherein the conductive film is made of poly-3,4-ethylenedioxythiophene/polystyrenesulfonate (PEDOT/PSS), polyaniline, polyacetylene, or polyphenylenevinylene.

5. The touch panel as set forth in claim 1, further comprising:
a first electrode wiring formed at an edge of the first electrode pattern; and
a second electrode wiring formed at an edge of the second electrode pattern and the conductive film.

6. The touch panel as set forth in claim 5, wherein the first electrode wiring is formed integrally with the first electrode pattern; and
the second electrode wiring is formed integrally with the second electrode pattern.

7. A touch panel comprising:
a first transparent substrate;
a first electrode pattern formed in a mesh pattern on one surface of the first transparent substrate;
a second transparent substrate;
a second electrode pattern formed in a mesh pattern on one surface of the second transparent;
a conductive film formed in a planar shape on one surface of the second transparent substrate;
an adhesive layer adhering one surface of the first transparent substrate and one surface of the second transparent substrate to each other; and
a display provided in a direction of the other surface of the second transparent substrate.

8. The touch panel as set forth in claim 7, wherein the first electrode pattern or the second electrode pattern is made of copper (Cu), aluminum (Al), gold (Au), silver (Ag), titanium (Ti), palladium (Pd), chromium (Cr) or a combination thereof.

9. The touch panel as set forth in claim 7, wherein the first electrode pattern or the second electrode pattern is made of metal silver formed by exposing/developing a silver halide emulsion layer.

10. The touch panel as set forth in claim 7, wherein the conductive film is made of poly-3,4-ethylenedioxythiophene/polystyrenesulfonate (PEDOT/PSS), polyaniline, polyacetylene or polyphenylenevinylene.

11. The touch panel as set forth in claim 7, further comprising:
a first electrode wiring formed at the edge of the first electrode pattern; and
a second electrode wiring formed at the edge of the second electrode pattern and the conductive film.

12. The touch panel as set forth in claim 11, wherein the first electrode wiring is formed integrally with the first electrode pattern; and
the second electrode wiring is formed integrally with the second electrode pattern.

13. A touch panel comprising:
a transparent substrate;
a first electrode pattern formed in a mesh pattern on one surface of the transparent substrate;
an insulating layer formed on one surface of the transparent substrate;
a second electrode pattern formed in a mesh pattern on an exposed surface of the insulating layer;
a conductive film formed in a planar shape on the exposed surface of the insulating layer; and
a display provided in a direction of the exposed surface of the insulating layer.

14. The touch panel as set forth in claim 13, wherein the first electrode pattern or the second electrode pattern is made of copper (Cu), aluminum (Al), gold (Au), silver (Ag), titanium (Ti), palladium (Pd), chromium (Cr) or a combination thereof.

15. The touch panel as set forth in claim 13, wherein the first electrode pattern or the second electrode pattern is made of metal silver formed by exposing/developing a silver halide emulsion layer.

16. The touch panel as set forth in claim 13, wherein the conductive film is made of poly-3,4-ethylenedioxythiophene/polystyrenesulfonate (PEDOT/PSS), polyaniline, polyacetylene or polyphenylenevinylene.

17. The touch panel as set forth in claim 13, further comprising:
a first electrode wiring formed at the edge of the first electrode pattern; and
a second electrode wiring formed at the edge of the second electrode pattern and the conductive film.

18. The touch panel as set forth in claim 17, wherein the first electrode wiring is formed integrally with the first electrode pattern; and
the second electrode wiring is formed integrally with the second electrode pattern.
